(19) United States
(12) Patent Application Publication
(10) Pub. No.: US 2025/0182173 A1
(43) Pub. Date: Jun. 5, 2025

(54) VENDING, STORAGE, INVENTORY MANAGEMENT, AND TRACKING SYSTEMS AND METHODS FOR CONSUMABLES

(71) Applicant: PLEASANTREES CANNABIS COMPANY, HARRISON TOWNSHIP, MI (US)

(72) Inventors: Jerome CRAWFORD, HARRISON TOWNSHIP, MI (US); Randall BUCHMAN, HARRISON TOWNSHIP, MI (US); D’angelo BRAGG, HARRISON TOWNSHIP, MI (US)

(21) Appl. No.: 18/843,761

(22) PCT Filed: Mar. 22, 2023
(86) PCT No.: PCT/US2023/015920

§ 371 Date: Sep. 4, 2024

Related U.S. Application Data
(60) Provisional application No. 63/322,399, filed on Mar. 22, 2022.

(51) Int. Cl. G06Q 30/0601; G06Q 20/18; G06Q 20/40; G07F 9/00

(52) U.S. Cl. CPC G06Q 30/0607; G06Q 20/18; G06Q 20/40145; G06Q 30/0631; G07F 9/00

(57) ABSTRACT

Described are vending and storage systems and methods for consumables, such as consumer packaged goods, and, in particular, to systems and methods that provide one or more of user verification, optimized storage conditions and monitoring of the consumer packaged goods, dispensing mechanisms, and virtual assistance to the user. Described are also systems and methods for automating and optimizing order fulfillment of products by tracking current inventory and analyzing inventory velocity for production planning.

### CROSS REFERENCE TO RELATED APPLICATIONS

This application claims priority to U.S. Provisional Patent Application No. 63/322,399, filed on Mar. 22, 2022, entitled “Vending and Storage Systems and Methods for Consumables,” which are incorporated herein by reference in its entirety.

### TECHNICAL FIELD

The present disclosure relates to vending, storage, inventory management, and tracking systems and methods for consumables, such as consumer packaged goods, and, in particular, to systems and methods that provide one or more of user verification, optimized storage conditions, monitoring of the consumer packaged goods, dispensing mechanisms, virtual assistance to the user, automated and optimized order fulfillment, inventory velocity, and production planning.

### BACKGROUND

Vending machines and kiosks provide convenience and accessibility to users. Vending machines are often used to hold and dispense certain food, drink, and non-perishables, such as school supplies, DVDs, and the like. For perishable items, including food and drink, the items generally have a long shelf-life and are not susceptible to moderate changes in environment or ambient conditions, such as changes in temperature, lighting, humidity, pressure, and the like. For example, these types of perishable items can include chips, candy, granola bars, and other prepackaged food. If chilled items are desired, such as chilled drinks or fruit, simple refrigeration can be used. The described perishable items common in vending machines may last days, weeks, and even upwards of several months before nearing an expiration date. Moreover, vending machines do not generally include restricted items, such as over-the-counter medications requiring an ID to purchase, alcohol, cigarettes, and the like.

There is a need for systems and methods for storing, monitoring, and dispensing consumer packaged goods, where the consumer packaged goods may require specific environmental conditions to maintain shelf stability, where the consumer packaged goods have a short shelf-life, and/or where identification and eligibility of the user may need to be determined prior to vending the consumer packaged goods to the user. There is a need for a smart network of kiosks that include one or more brands of consumer packaged goods, that can receive, store, and transmit to a user, pricing, brand, and other data across the network of kiosks, and that optionally include virtual assistance, such as questionnaires or access to customer service representatives to assist the user in their selection of the consumer packaged goods.

As agricultural products have limited shelf-life and take time to grow, backup inventory may not be an option. Therefore, there is a need for a system that facilitates automated and optimized fulfillment of agricultural products including determining sales velocity and sell-through rate of products to optimize profitability.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure and in any section of this disclosure thereof.

Described is a kiosk for dispensing regulated consumables comprising an exterior housing, a product storage cavity within the exterior housing, a user interface, one or more verification area, a dispensing area, and one or more sensors to sense inputs and output instructions related to dispensing the regulated consumables. The inputs and output instructions may comprise verifying instructions, eligibility determining instructions, dispensing instructions, instructions related to storage conditions, instructions for alerts, instructions for collection and storage of data, or instructions for virtual assistance. The data may comprise user data, brand data, loyalty programs, shelf-life, or pricing.

The exterior housing may be a protective or secure housing to prevent unauthorized access to components and products held within the kiosk and includes one or more secure doors or access points to the product storage cavity. The materials and colors of the exterior housing may be chosen based on brands or products within the kiosk or chosen based on humidity or temperature control. The materials and colors of the storage cavity may be similar or different than the exterior housing and chosen based on humidity or temperature control.

The user interface may facilitate interaction between a user and the kiosk and facilitate selection of the regulated consumables by the user, wherein the user interface may show instructions or prompts to guide the user through verification, selection, and dispensing procedures. The user interface may comprise a display or on or more manual buttons. The user interface may comprise a component to receive tender including dollar bills, coins, credit and debit cards, mobile payment, or a combination thereof. The user interface may communicate to dispensing mechanisms to facilitate dispensing of selected product to the dispensing area. The user interface may display a series of questions as part of a questionnaire, which comprises targeted questions to understand which product may best suit a user's needs and wants. The user interface may display an option to connect to a third party such as a virtual sales person or customer representative, wherein the virtual sales person or customer representative provide an assessment and make recommendation through the user interface.

The verification area may comprise slots configured to receive identification such as identification (ID) cards, fingerprint, facial recognition, or a combination thereof. The verification area may comprise one or more barcode readers, cameras, sensors, or a combination thereof. The storage cavity may comprise one or more sensors such as temperature sensors, moisture sensors, pressure sensors, or a combination thereof, to monitor corresponding conditions.

Described is also a regulated consumable dispensing system comprising a processor operably coupled to a memory that executes computer executable components stored in the memory. The computer executable components may comprise a verification component that assess eligibility of a user to receive selected product based on one or more identifiers, a storage component that assesses and controls environmental conditions in a storage cavity that stores the regulated consumable, dispensing component that dispenses to the user the selected product, and an assistance component that provides guidance to a user for selection of a product. The guidance may comprise questionnaire or communication with a virtual sales person or customer representative. The environmental conditions may comprise temperature, humidity, or lighting that is relevant to freshness and shelf-life of the regulated consumable inside the storage cavity of a kiosk. The storage component may adjust the environmental conditions through increased or decreased ventilation, cooling or heating, humidifiers or dehumidifiers, light or darkness, different colored or intensity of lights within the storage cavity.

Described is also a method for verifying product purchase eligibility that may comprise verifying, by a system, that a user at a kiosk matches identification provided by the user. The method may further comprise assessing, by the system, eligibility of the user to receive selected product based on one or more identifiers. The method may further comprise optionally assessing, by the system, user history at one or more kiosks. The method may further comprise optionally comparing, by the system, the user history to current quantity selection to determine if quantity limitations are exceeded. The method may further comprise dispensing, by the system, to the user the selected product.

Described is also a method for automating and optimizing order fulfillment that may comprise receiving, by a sales modeling platform, an order for a customer from a dispensary's point-of-sale (POS) system. The method may further comprise checking, by the sales modeling platform, the dispensary's inventory to ensure a product in the order received is in stock. The method may further comprise prioritizing, by the sales modeling platform, one or more orders based on several factors such as product availability, customer location, and delivery requirements. The method may further comprise consolidating, by the sales modeling platform, the one or more orders that are going to a similar location or have a similar delivery requirements. The method may further comprise optimizing, by the sales modeling platform, shipping route, carrier selection, and delivery time to ensure timely and accurate delivery. The method may further comprise generating, by the sales modeling platform, a shipping label for a selected carrier. The method may further comprise sending, by the sales modeling platform, a notification, via a dashboard interface, to the customer with the tracking information and expected delivery date. The order information may comprise details such as product name, category, quantity, or a combination thereof.

If the product is not available, the method may further comprise prioritizing, by the sales modeling platform, the one or more orders based on availability and notifying the customer of any potential delays. The one or more orders with urgent or high-priority products or those with time-sensitive delivery requirements are given priority.

If one or more customers in a similar area ordered similar products, the method may further comprise consolidating, by the sales modeling platform, the similar products and arrange for a single shipment to the similar area to reduce shipping costs and improve delivery times. The method may further comprise utilizing, by the sales modeling platform, real-time shipping data to determine most cost-effective and efficient shipping methods for the one or more orders. The method may further comprise factoring in, by the sales modeling platform, carrier availability and peak delivery periods to optimize the delivery time. The shipping label may comprise relevant order information such as customer's name and address, product details, and delivery requirements.

Described is also a system for automating and optimizing order fulfillment of products. The system may comprise an enterprise resource planning (ERP) platform that provides procurement planning, production planning, inventory planning, sales planning, and distribution and logistics planning. The system may further comprise a point-of-sale (POS) system that provides inventory management, sales data, and customer analytics. The system may further comprise a sales modeling platform that facilitates production, ordering, and logistical planning using intelligent algorithms that predict future needs. The system may further comprise a dashboard interface coupled with the sales modeling platform as a means of communication between producers and retailers. The POS system may be a brick-and-mortar based system, a kiosk-based system, or a delivery app-based system. The sales modeling platform may provide logistics and routing solutions for on-time inventory maintenance driven by real time inventory view and sell-through. The sales modeling platform may use machine learning and predictive analytics to dynamically predict inventory needs and sell-through for the products, thereby allowing the retailers and dispensaries to optimize inventory levels and avoid overstocking.

The following description and the drawings disclose various illustrative aspects. Some improvements and novel aspects may be expressly identified, while others may be apparent from the description and drawings.

### DESCRIPTION OF THE DRAWINGS

The accompanying drawings illustrate various systems, apparatuses, devices and methods, in which like reference characters refer to like parts throughout.

FIG. 1 is a graphic depicting an embodiment of a vending machine for consumer packaged goods in accordance with various disclosed aspects herein;

FIG. 2 is a graphic depicting an embodiment of a method associated with a vending machine for consumer packaged goods in accordance with various disclosed aspects herein;

FIG. 3 is a graphic depicting an embodiment of a system associated with a vending machine for consumer packaged goods in accordance with various disclosed aspects herein;

FIGS. 4A, 4B, and 4C is a block diagram of an example system to granularly track agricultural products from production through sales in accordance with various disclosed aspects herein;

FIGS. 5A, 5B, and 5C is a block diagram of an example system to granularly track products from production through sales in accordance with various disclosed aspects herein;

FIG. 6 is a block diagram of an example software system to implement the example systems of FIGS. 4A, 4B, 4C and 5A, 5B, 5C in accordance with various disclosed aspects herein;

FIG. 7 is a graphic depicting an embodiment of a method associated with a sales modeling platform to optimize the order fulfillment process in accordance with various disclosed aspects herein; and

FIGS. 8A-F illustrate a graphic depicting an embodiment of an algorithm to calculate inventory velocity for inventory management and planning in accordance with various disclosed aspects herein.

### DETAILED DESCRIPTION

Reference will now be made in detail to exemplary embodiments, examples of which are illustrated in the accompanying drawings, wherein like numbered aspects refer to a common feature throughout. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

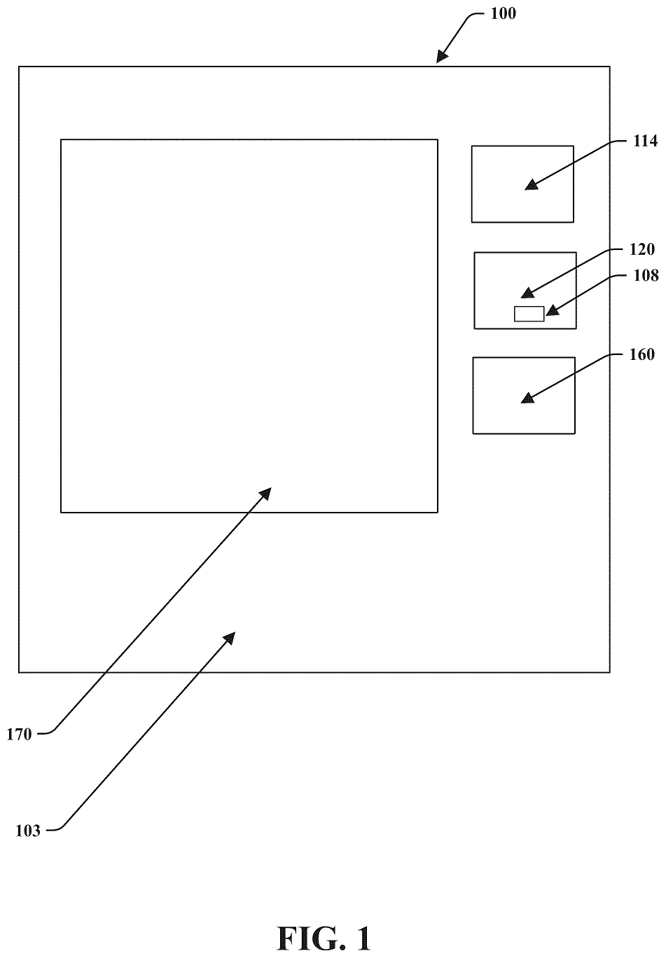

Turning to FIGS. 1-3, shown is a vending machine or kiosk 100, and methods 200 and systems 300 that may be used with kiosk 100 or with other known kiosks in the art. Although kiosk 100 is described herein and embodiments may incorporate kiosk 110 as part of the system and methods described, it is noted that the described systems, methods, and processes may also be offered or used independently from kiosk 100 and adapted to other known kiosks in the art (e.g. a software offering, service model, or subscription based model). It is further noted that the terms “vending machine” and “kiosk” as used herein are not limiting and are interchangeable unless this disclosure or context suggests otherwise. The terms “vending machine” and “kiosk” should be understood to broadly cover systems that can store, dispense, vend, etc.

The disclosure relates generally to one or more of (or all): (1) user verification methods and systems, including, for example, the determination and confirmation of user identification and/or user eligibility, (2) storage methods and systems for consumer packaged goods, including consumer packaged goods having a short or less stable shelf-life and/or requiring certain optimal ambient conditions for preservation, (3) dispensing methods and systems for dispensing the consumer packaged goods to a user based on, for example, user verification, user eligibility, restricted access, shelf-life of the product, etc., (4) a virtual assistance platform, such as a pre-selected questionnaire or access to a real-time customer representative that can assist in the selection of consumer packaged goods, answer questions, assist or troubleshoot any of the described systems and methods, and the like (5) a kiosk for storing and dispensing consumer packaged goods and that can effectuate or include the described systems and methods, and (6) a business model, such as a networking model, pricing model, brand model, etc., that bridges the described systems and methods into existing businesses, for example, (e.g. “shop within a shop”). It is noted that this list is not inclusive or limiting.

Generally speaking, dispensable products may include or be referred to interchangeably as consumables, consumer packaged goods, goods, and the like unless context or this disclosure suggests otherwise. The products may be individually packaged or provided in bulk and packaged automatically on-site based on user selection. The products may include perishable products. The products may include perishable products that require certain environmental conditions to maintain freshness, shelf-stability, efficacy, etc. The products may include agricultural items. The products may include, for example, produce, dairy products, meat products, and the like. The products may include products that are restricted to certain users or in certain quantities. The products may include, for example, alcohol, cigarettes, tobacco or nicotine products, cough medicine or other over-the counter drugs. The products may include cannabis, cannabinoids, and cannabis/cannabinoid related products, such as products containing tetrahydrocannabinol (THC).

Shown in FIG. 1 is an embodiment of kiosk 100. Kiosk 100 may generally include an exterior housing 103, a product storage cavity 170 within the exterior housing 103, a user interface 114, one or more verification area 120, and a dispensing area 160. The systems and methods may further comprise one or more sensors 108 and logic, as well as processor(s) 304, memory 302, controller(s) 306, and the like, to sense certain inputs and output instructions such as verifying instructions, eligibility determining instructions, dispensing instructions, instructions related to storage conditions, instructions for alerts, instructions for the collection and storage of data (e.g. user data, brand data and loyalty programs, shelf-life, pricing, etc.), instructions for virtual assistance, etc.

Exterior housing 103 may be a protective or secure housing and may prevent unauthorized access to components and products held within the kiosk, e.g., within a product storage cavity 170 or within a cavity housing the electrical components and inner workings of the system. Exterior housing 103 may also include one or more secure doors or access points to the entire interior, to the storage cavity 170 and separately the cavity housing the electrical components, etc. The kiosk 100 may include several protections, e.g. alerts for unauthorized tampering, alerts if an ineligible user attempts a purchase, alerts if verification is suspected to be forged, alerts if a door is left open, alerts if a door is open for a certain length of time, if environmental conditions within the kiosk 100 are fallen outside of desired parameters, etc. Alerts may include visual alerts, auditory alerts, etc. The alerts may occur in real time at the kiosk 100, may be transmitted in real time across a network to appropriate persons such as the store manager or security, vendor, brand, or the like, may be delayed until maintenance or restocking is initiated, or delayed and stored until a request for the information is initiated.

Exterior housing 103 may be any appropriate material, including metals, plastics, glass, combinations of two or more thereof, and the like. Exterior housing 103 may be any appropriate color or colors. In an example, the kiosk 100 may include a window of transparent material, e.g., glass or plastic, to show the current inventory of products within the storage cavity. The transparency may apply to the entire size of the storage cavity 170 on the user facing side, to a portion of the storage cavity on the user facing side, or on one or more sides of the storage cavity including or not including the user facing side. In an example, the kiosk 100 may include no transparency.

The materials and colors of the exterior housing 103 may be chosen based on the brands or products within the kiosk 100. For example, the colors may identify to the user which brands of a product are sold within the kiosk 100 (e.g. brand specific aesthetic customizations). For example, the materials and colors may assist in effectuating a desired environment or preventing certain conditions within the storage cavity 170 or other interiors of the kiosk 100. The materials and colors may be chosen to reduce, maintain, or increase humidity (e.g., insulated elements, vents, lights, heat lamps, etc.), to reduce, maintain, or increase temperature (e.g., black versus white, transparent vs. nontransparent, metal vs. plastic, etc.). The materials and colors of the storage cavity 170 may be the same or different than the exterior housing 103, and may include any of the foregoing examples described in reference to the exterior housing 103.

User interface 114 may facilitate interaction between a user and the kiosk 100, may facilitate selection of the desired products by the user, and may show instructions or prompts to guide the user through the verification, selection, and dispensing procedures, such as by displaying instructions or guidance (e.g., “please insert ID card,” “please select product,” “verification unsuccessful,” “take questionnaire,” “contact customer representative,” etc.). These prompts are not limiting and instead illustrate a few of the myriad of options for guiding a user through the various methods and systems described herein.

In an embodiment, the user interface 114 may include a display. In an embodiment, the user interface 114 may include one or more manual buttons. In an embodiment, the user interface 114 may include a touch screen. User interface 114 may include a component to receive tender, including dollar bills, coins, credit and debit cards, mobile payment, and the like. User interface 114 may guide a user through the systems and methods of verification, eligibility, selection of product, and payment. Upon completion of the prompts, the user interface 114 may communicate to the dispensing mechanisms and facilitate dispensing of the selected product to the dispensing area 160 where the user can receive the selected product.

In an embodiment, the described kiosks 100, methods 200, and systems 300 (FIGS. 1-3 respectively) may be capable of transacting. In an embodiment, the described kiosks 100, methods 200, and systems 300 may be capable of collecting and communicating certain data or information. In an example, the data or information can include inventory, sales data, current environmental conditions, when environmental conditions fall outside of set parameters, errors, low stock, restocking events, attempted use by users that are not eligible (e.g. not of a certain age) etc. In an embodiment, the described kiosks 100, methods 200, and systems 300 may do one or more (or all) of the following: receive the information, evaluate the information, store the information, transmit the information internally to other components of the kiosk or system, transmit the information externally across a network or communication framework 390, transmit the information to another device, such as a hub, computer, phone, tablet, etc., or to any other online system, such as a cloud.

It is noted that the described kiosks 100, methods 200, and systems 300 may include wireless communication capabilities across a network or communication framework. The framework may be Ultra Wideband (UWB). The framework may be Bluetooth®, Wi-Fi®, or ZigBee®. The framework may be Bluetooth® low energy (Bluetooth® LE or BLE). The framework may be a combination of two or more of Bluetooth®, UWB, Wi-Fi®, ZigBee® or BLE.

In an example, user interface 114 may display a series of questions as a part of a questionnaire. The questionnaire may include targeted questions to understand which product may best suit the user's needs and wants. For example, if the user has more or less experience with the type of product, or indicates they want a certain taste, a certain strength or concentration of a product, certain therapeutic benefits such as focus, relaxation, anxiety relief, etc., certain price points, certain brands, etc., the user interface 114 (and processor(s) 304, memory 302, controller(s) 306, thereof) can compare the user answers to a catalog of answers to narrow down which product or products fall within the parameters identified by the user's answers to the questions. The user interface 114 (and components thereof) can provide a recommendation for products that match the user's identified preferences. Such questionnaire and product determination may be automatic upon input received by the user (e.g., not requiring a third party).

In an example, user interface 114 (and processor(s) 304, memory 302, controller(s) 306, communication framework, thereof) may display the option to connect to a third party, such as a virtual sales person or customer representative. The virtual sales person or customer representative may be ask questions or speak with the user to understand which product may best suit the user's needs and wants. For example, if the user has more or less experience with the type of product, or indicates they want a certain taste, a certain strength or concentration of a product, certain therapeutic benefits such as focus, relaxation, anxiety relief, etc., certain price points, certain brands, etc., the virtual sales person or customer representative can evaluate the user's responses and provide an assessment through the user interface 114 of a product or products that fall within the parameters identified by the user's answers to the questions. The virtual sales person or customer representative can provide a recommendation for products that match the user's identified preferences through the user interface 114 (and components thereof).

The user may correspond with the virtual sales person or customer representative through the user interface 114 by text or writing, by voice, by video, or any combination of the foregoing. For example, the user may voice their answers in response to a written question by the virtual sales person or customer representative or vice versa where the user may type or select a type-written answer in response to a question vocalized by the virtual sales person or customer representative. For example, the user may type or select a type-written answer in response to a written question by the virtual sales person or customer representative, the user may voice their answers in question vocalized by the virtual sales person or customer representative, the user may video chat with a virtual sales person or customer representative, etc. Depending on the type of user interaction desired, the kiosk 100 and user interface 114 may include such features as microphones, speakers, cameras, video displays, text displays, physical button keyboards or touch screen keyboards, and the like.

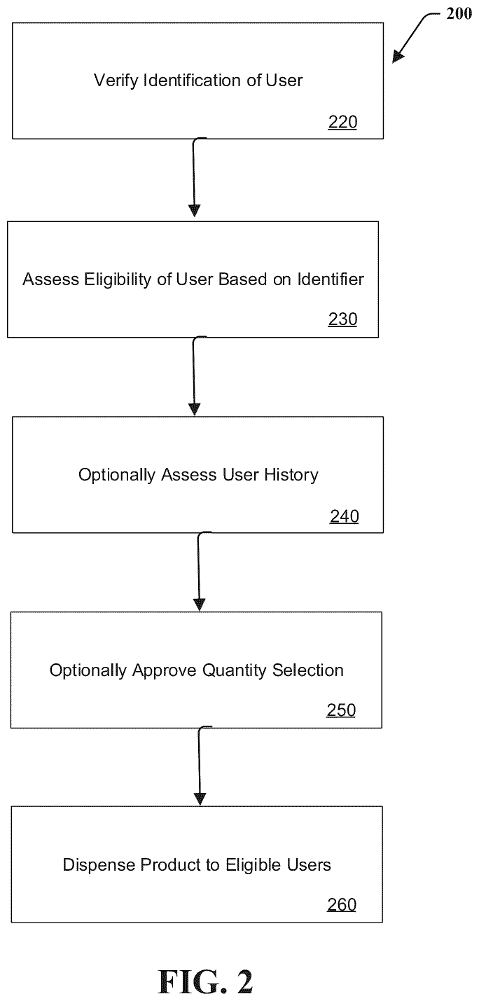

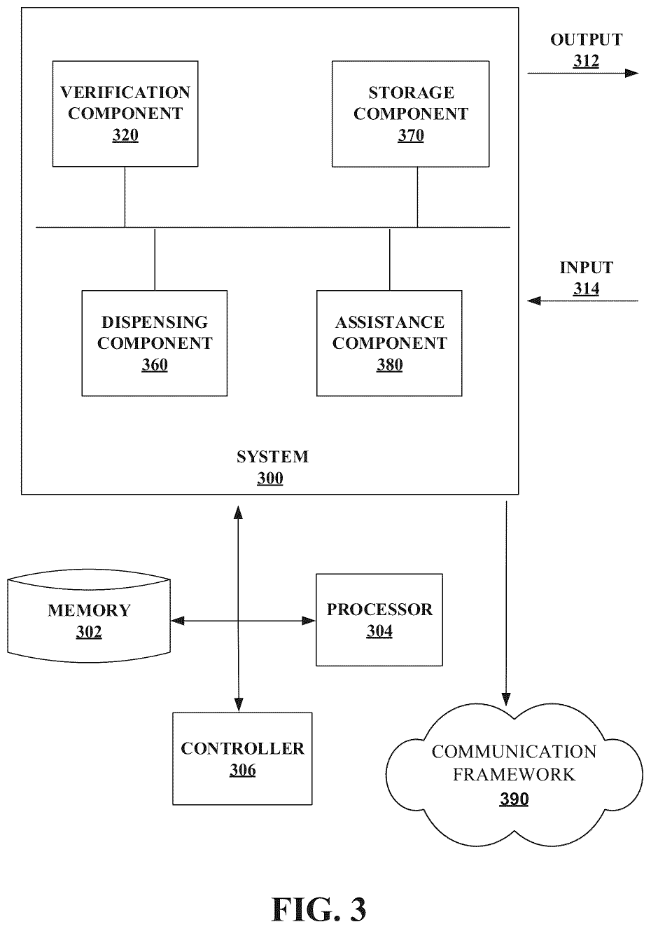

Verification area 120 may generally house or communicate with the verification component 320, based on input 314 by the user shown and described in reference to FIG. 3, to verify a user's identity and eligibility (e.g. steps 220, 230 in FIG. 2). Verification area 120 and verification component 320 may include slots configured to receive identification, including ID cards, may include fingerprint or facial recognition technology, and the like. Verification area 120 and component 320 may include one or more barcode readers, cameras, sensors, and the like.

For example, the verification component 320 can verify that the user at the kiosk 100 matches the identification provided by the user 314 through the verification area 120 (e.g. step 220 in FIG. 2).

For example, the verification component 320 can assess eligibility of the user to receive the selected product based on one or more identifiers (e.g. step 230 in FIG. 2). The identifiers, for instance, may be ascertainable from the identification provided by the user 314 through the verification area 120, such as age. In an embodiment, the products may only be provided to users above a certain age, such as 16 or older, 18 or older, 21 or older, 25 or older, etc. Only users that fulfill this certain age (or other identifier) can be eligible to receive the age-restricted product. Users that do not fulfill this certain age (other identifier) or that cannot otherwise “satisfy” or “pass” the verification and eligibility assessments in steps 220, 230, may be locked out of the kiosk 100. For example, the kiosk 100 may not turn on or may not show inventory until these steps 220, 230 are complete.

Additionally, the products may also be quantity-restricted such that the same user cannot purchase a certain quantity of product even if separate transactions are made. The quantity limitations may apply to one kiosk over a certain timeframe, may apply to a network of kiosks over a certain timeframe, and the like. The quantity limitations may be effectuated by optionally assessing user history at one or more kiosks (step 240) and optionally comparing the prior user history to the current quantity selection (step 250) to determine if the quantity limitations are exceeded. The kiosk can also only allow the user to make a quantity selection that is within the permissible quantity after assessing user history at one or more kiosks (step 240).

User interface 114 may generally house or communicate with the assistance component 380, based on input 314 by the user shown and described in reference to FIG. 3, to guide the user through selection of a product (e.g. optional steps between 220 and 260 in FIG. 2, and may be part of steps 230, 240, 250 and occur concurrently or sequentially with these steps). Such guidance may include the questionnaire or communication with a virtual sales person or customer representative as described herein.

Storage component 370 may generally assess and control the environmental conditions in storage cavity 170. For example, certain temperature, humidity, lighting, etc. conditions may be relevant to the freshness and shelf-life of the products in the kiosk 100. Storage cavity 170 may include one or more sensors, such as temperature sensors, moisture sensors, pressure sensors, and the like, to monitor the corresponding conditions, and receive and transmit this sensed information to the storage component 370. Storage cavity 170 may include one or more lights, including lights of different temperatures, brightness, color, etc. The system 300 may include certain desired parameters or ranges for the conditions so that the storage component 370 can adjust conditions through increased or decreased ventilation, increased cooling or heating of the storage cavity 170, humidifiers or dehumidifiers, light or darkness, different colored or intensity of lights etc. within the storage cavity 170. Such monitoring and maintaining of environmental conditions that the product is exposed to in the storage cavity 170 and kiosk 100 can help ensure and extend the shelf-life of the products. In an embodiment, weight sensors may be used within the storage cavity 170 to monitor how long certain inventory has been within the kiosk 100, e.g., the weight of the product is sensed by the weight sensor when stocked and the weight of the product is no longer sensed by the weight sensor once the individual product has been dispensed to the user and is no longer in the kiosk 100.

Dispensing area 160 may generally house or communicate with the dispensing component 360, based on input 314 by the user shown and described in reference to FIG. 3, to dispense to the user the selected product (e.g., step 260 after other steps 220, 230, 240, 250 in FIG. 2). Dispensing area 160 may include a slot that opens or unlocks to allow access by the user to the dispensed product.

FIG. 2 shows an example of a method 200 that may be used to dispense product to certain verified and/or eligible users. The method 200 is meant to be exemplary and it is noted that other methods not illustrated in FIG. 2 are also contemplated, including changing order of steps, including additional steps, and omitting steps.

Disclosed are distribution models and methods for storing and dispensing products within a kiosk. The kiosks may be placed in a variety of different stores and many provide a “shop within a shop” experience. Pricing of the products may be variable based on age of the products and estimated remaining shelf-life and prices may be automatically reduced after a certain time has passed or based on the estimated expiration date of the product. Brand loyalty may be tracked through the kiosks and users may be able to participate in brand loyalty programs regardless of the specific location or kiosk. The kiosks may house one brand or more than one brand, for example, two, three, four, five, six, seven, eight, etc. brands. The kiosks may be located at a store selling brand A and the kiosks may also sell brand A or the kiosks may sell brand B or both brand A and B, in an example. The product may be provided on a consignment basis.

Embodiments disclosed herein may also facilitate automated fulfillment for agricultural productions such as cannabis operations. More specifically, utilizing real time data such as sales and market trends as it relates to actual product strains that are selling through a retail cannabis location, to analyze and predict what products should go into the ground to increase profitability. The embodiments disclosed herein may also facilitate determining which highest value product, plant, or material should be placed into the ground and at what time.

The growing season may be year-round. The outdoor growing season may last from early spring to fall, and there is the indoor growing season that may take place in big warehouses with lighted canopy which enables year-round operations. Cycle time from seed to harvest may typically be about 150 days. As an agricultural product that takes time to grow, there are certain kind of limitations on the ability to create or manufacture backup inventory and maintain inventory control or inventory management. Typical agricultural products may have the same strain grown in the same environment. However, cannabis products is biologically complex with hundreds of different strains and chemical entities. The embodiments herein may account for the molecular makeup of a cannabis plant in determining which products or strains would be most profitable and what growing conditions are ideal for similar plants by tracking the growing conditions of the plants or products. Environmental variables such as slight changes in temperature may change a particular batch of strain to become a different batch. These data may be built into an algorithm to determine how to allocate a particular flower strain of harvest as harvest day nears. Environmental variable from the time a seed is planted until a plant is harvested may be tracked. Recommendations may be made based on the terpene profile of a plant and how it performed over time under different environmental variables that change throughout the lifecycle of that particular plant.

From seed planting to harvest, the environmental data may be automatically tracked, manually entered, or a combination thereof. There may be a multi-step grading system such as a five-step grading system for a flower bud once it is harvested and dried, and either before or after the curing phase. The bud may be graded based on a number of factors such as five factor system. For example, the bud may be graded based on bud density, the quality of the dry, the trichomes on it, etc. The grade of the bud and test results for tetrahydrocannabinol (THC) and cannabinoids may determine the grading scale for a bud. Based on this grading scale, that bud may be assigned to a particular brand, product, SKU (stock keeping unit), etc. The bud may be graded using an automated system, graded manually, or a combination thereof. For example, artificial intelligence and different kind of sensors may be used to grade the buds based on visual image and smell of the buds. A database of images and smell characteristics may be used to train a machine learning model. Visual sensors and electronic nose sensors may be used for automatic grading of the buds.

As new products and flower buds are being produced, assessments may be made as to inventory, labor force, and prediction for future products. So as to not overstock, current inventory may be checked and assessments may be made based on production scheduling and sales velocity of new strains. Current production schedule may be analyzed to determine the available labor force at any given time as to what may be realistically be produced. As new products become available, planting time and labor force may be reallocated based on profitability.

Allocation to retail locations may depend on level of partnership. Certain retail locations may have premium allocation based on their desires or needs. The rest of the inventory may then be available to the open market and sales representative. If requested by a retail location, inventory management services may be provided for that retail location. Inventory management for retail location may be based on expiration dates, salability, number of days on the market, current sell-through, etc. Inventory management may include providing recommended discounts and credits to the retailer for specific products based on quality standards. At a predetermined amount of time prior to expiration of a product, a retailer may receive an auto discount for those products which they may be able to pass on to the consumers. The goal is to not get unsold products back from the retailer.

Sales information may be tracked so that historical sales data such as, but not limited to, how long a product stayed in inventory, price, and profit margin may be used to determine what seeds go into ground.

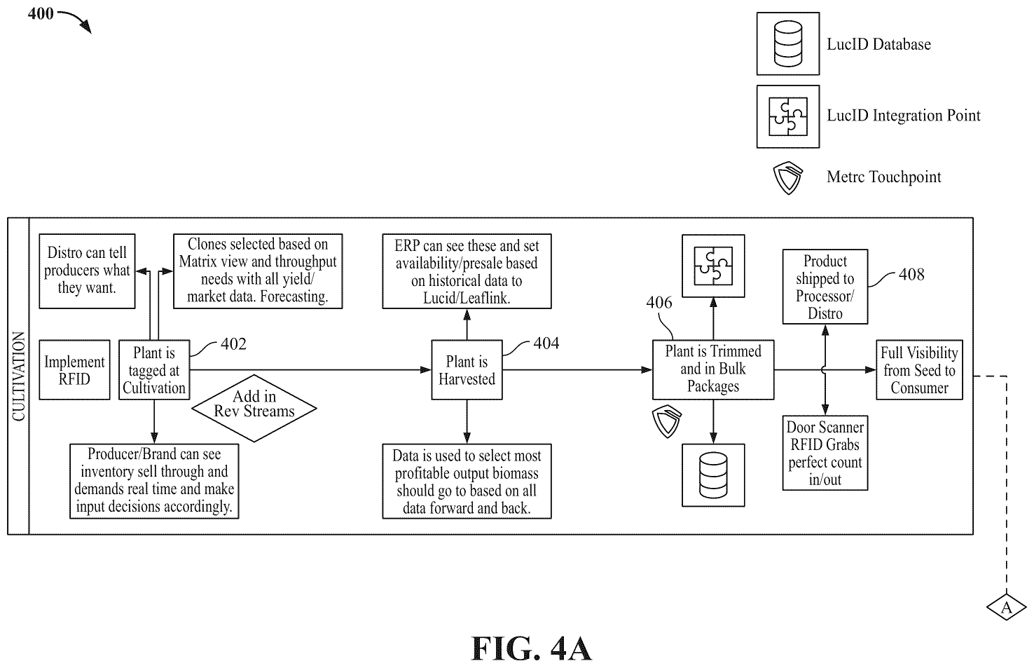

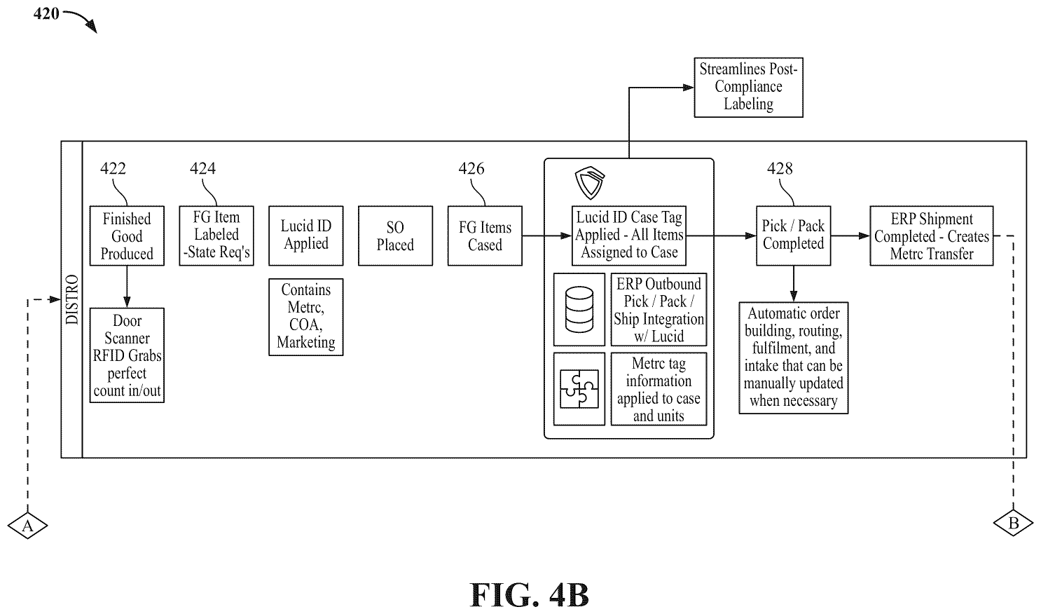

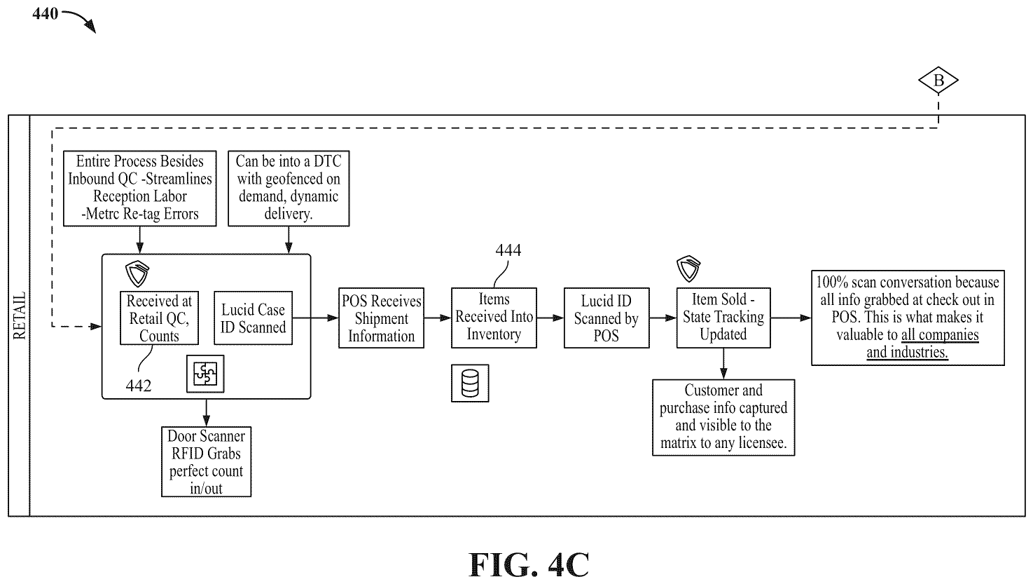

FIGS. 4A, 4B, and 4C illustrate an example system to granularly track agricultural products from cultivation through sales. The system illustrated in FIGS. 4A, 4B, and 4C tracks, for example, radio frequency identification (RFID) tags that are applied to individual units of a product meant for retail sale (e.g., to the smallest unit of the product that is intended for individual retail sale) (sometimes referred to as a “retail unit”) through manufacture (e.g., “cultivation) to distribution to a retail point-of-sale (POS) system (e.g., as integrated into a kiosk, etc.). One or more databases track the retail unit through these stages as the RFID tags move through RFID tag readers associated with a location. This tracking data may be provided in near-real time to each of the entities controlling the various states (e.g., a manufacturer, a distributor, a retailer, etc.). For each type of retail unit, the system may build a distribution tree starting at the manufacturer, branching to each distributor, and further branching from each distributor to each retailer associated with the distributor. This data may be used by manufacturing control systems, logistic planning system, and/or automated retail order systems to technically integrate disparate systems. FIG. 4A illustrates the system from the perspective of an agricultural producer. FIG. 4B illustrates the system from the perspective of a distributor (e.g., of agricultural products) connected to one or more agricultural producers via label “A.” FIG. 4C illustrates the system from the perspective of a retailer (e.g., of agricultural products) connected to one or more distributors via label “B.”

FIG. 4A illustrates that the Lucid Database, Lucid Integration Point, and Metrc Touchpoint may be used. However, other standard database and software applications may be used. Lucid Integration Point may be used to track product data and facilitate communication between different POS systems and Metre Touchpoint. Metre Touchpoint may be used to ensure compliance with regulatory requirements.

During the cultivation phase 400, in FIG. 4A, a plant is tagged at cultivation (block 402). The plant may be tagged with an RFID tag and added into revenue streams. Revenue streams enable the ability to track revenue from different sources such as wholesale and direct-to-consumer (DTC) sales. This information can be used to inform business decisions and make forecasts. This is a valuable service to businesses. As plants are tagged and monitored, clones are selected based on a matrix view and throughput needs with all yield/market data that may be used to make forecasts. A distributor may also tell producers what products they want. A producer or brand may be able to see inventory sell-through and demands in real time and make input decisions accordingly.

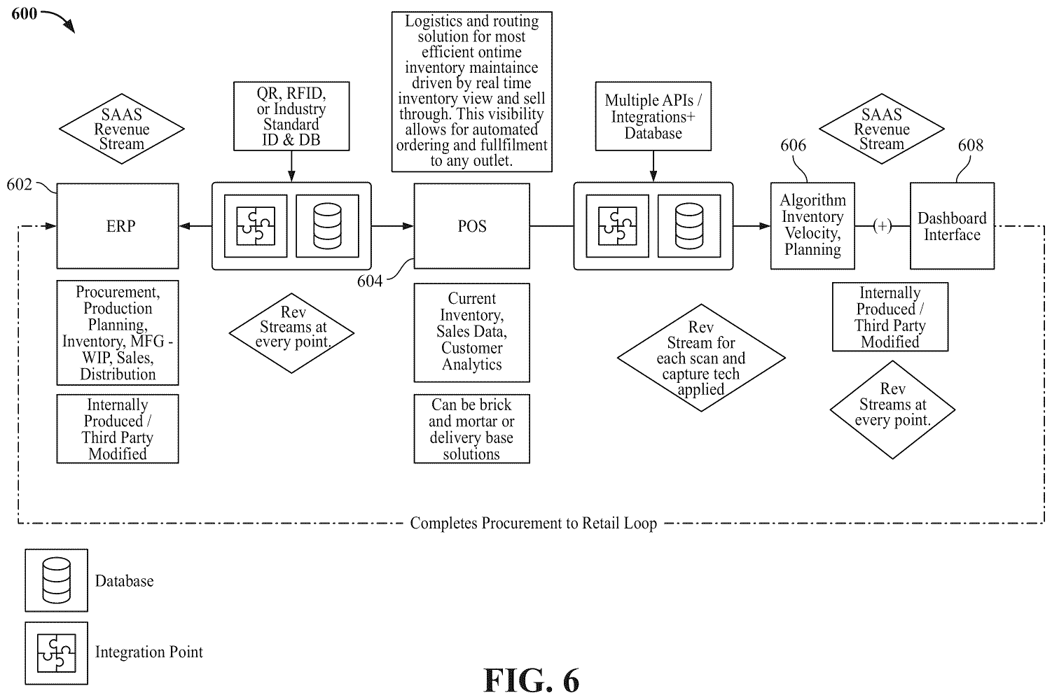

As a plant is harvested (block 404), enterprise resource planning (ERP) may be able to see these sell-through and demands and set availability/presale based on historical data to Lucid/LeafLink. Lucid and LeafLink may integrate ERP with the larger system (e.g., system 600 in FIG. 6), allowing for visibility into historical data and pre-sale availability. As such, data is used to select the most profitable output biomass based on all the data forward and back.

After harvesting, a plant is trimmed and bulk packaged (block 406). During this stage, Lucid Integration Point may be used to track product data and add such data to the Lucid Database. The bulk packages may be shipped to the processor/distributor (block 408). During this process, a door scanner may grab data encoded in the RFID tag of a plant to perfect count in and out. This may enable full visibility from the time a seed is planted until it reaches the consumer as a harvested and packaged plant product.

In FIG. 4B, the distribution phase 420 may begin with a finished good produced (block 422) and a door scanner may grab data encoded in the RFID of the good produced to perfect count in and out. The finished good (FG) may be labeled according to state requirements (block 424). At this stage in the process, Lucid ID (identification) may be applied, which may contain Metrc Touchpoint information to ensure compliance with regulatory requirements, certificate of analysis (COA), and marketing data. Sales order (SO) may be placed and the finished good (FG) items may be cased (block 426).

Lucid ID may be used to track a product from production to sale, allowing for better inventory management and customer tracking. Metrc Touchpoint may work in collaboration with a Lucid ID Case Tag to ensure compliance with regulatory requirements. This allows for post-compliance labeling to be streamlined. ERP may also integrate with Lucid Integration Touchpoint for outbound pick, pack, ship automation. After pick/pack is completed (block 428), the automatic order building, routing, fulfillment, and intake processes may streamline the workflow, with the ability to be manually updated when necessary. As ERP shipment is completed, a Metrc transfer is created to facilitate the transfer of inventory from one licensed facility to another.

In the retail phase 440, as illustrated in FIG. 4C, products may be received at a retail location which may entail quality control (QC) and counting of the product items (block 442). This process may implement Lucid Integration Point and Metrc Touchpoint and Lucid Case ID is scanned. This entire process besides inbound QC may be streamlined. For example, the reception labor and Metrc Re-tag Errors may be streamlined. Streamlining the reception labor involves automating processes such as quality control and tracking Metrc Re-tag Errors. Instead of going through a retailer, this process may also be a direct-to-consumer (DTC) sales. A DTC sales with geofenced on-demand dynamic delivery may refer to the ability to sell products directly to consumers with delivery options based on their location. A door scanner may grab data from an RFID tag of received products to perfect count in and out.

The point of sales (POS) system may receive shipment information and items are received into inventory (block 444). The Lucid Database may also be updated with this inventory information as the Lucid ID is scanned by the POS system. As items are sold, state tracking may be updated while Metrc Touchpoint may ensure compliance with regulatory requirements and state tracking may be update. Customer and purchase information captured may be visible to any licensee, which may include dispensaries and retailers. Conversations may be scanned 100% because all information may be grabbed at check-out by the POS system. This is what makes it valuable to all companies and industries. For example, communications with the system 300 may be scanned for analytics.

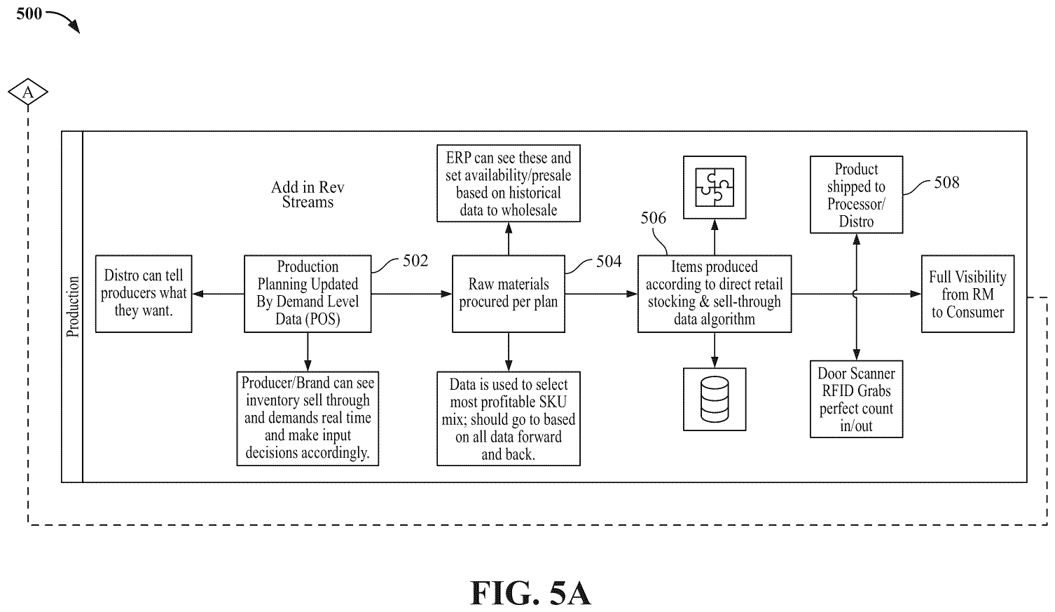

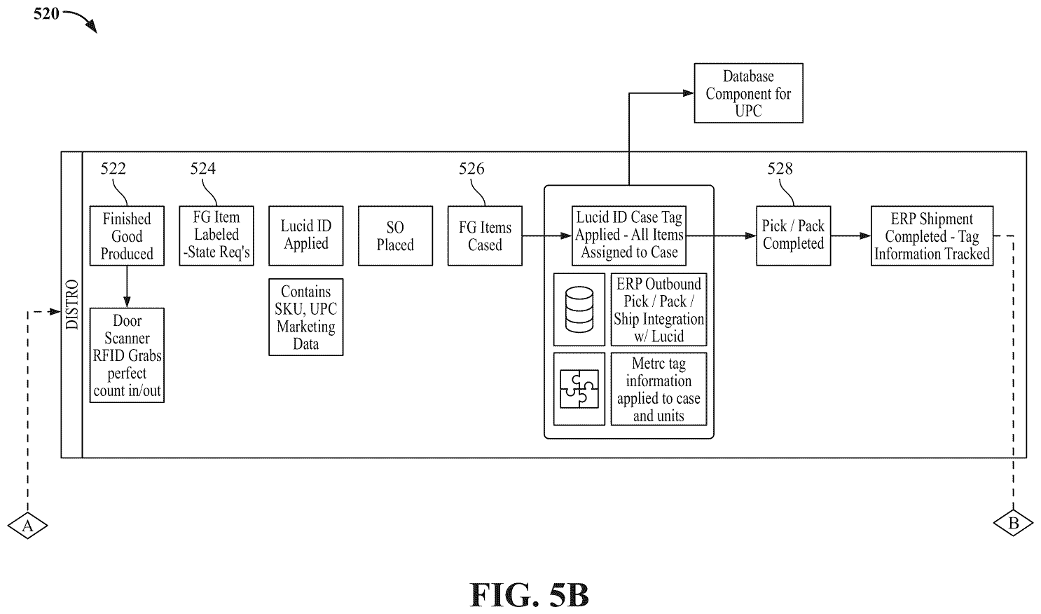

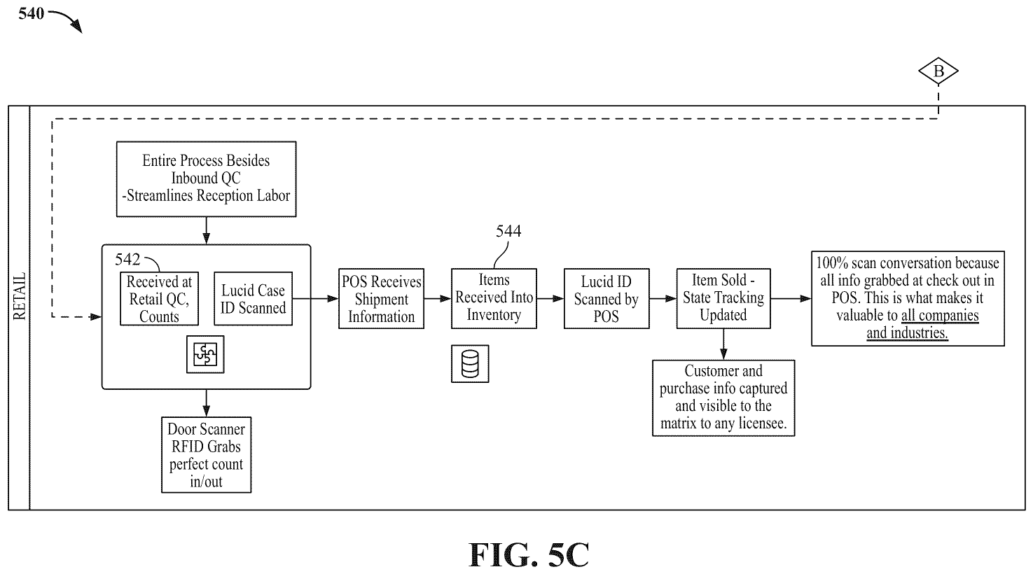

FIGS. 5A, 5B, and 5C illustrate an example system to granularly track products from production through sales. The system illustrated in FIGS. 5A, 5B, and 5C tracks, for example, radio frequency identification (RFID) tags that are applied to retail units of a product meant for retail sale through manufacture to distribution to a retail point-of-sale (POS) system (e.g., as integrated into a kiosk, etc.). One or more databases track the retail unit through these stages as the RFID tags move through RFID tag readers associated with a location. This tracking data may be provided in near-real time to each of the entities controlling the various states (e.g., a manufacturer, a distributor, a retailer, etc.). For each type of retail unit, the system may build a distribution tree starting at the manufacturer, branching to each distributor, and further branching form each distributor to each retailer associated with the distributor. This data may be used by manufacturing control systems, logistic planning system, and/or automated retail order systems to technically integrate disparate systems. FIG. 5A illustrates the system from the perspective of a producer of goods. FIG. 5B illustrates the system from the perspective of a distributor connected to one or more producers via label “A.” FIG. 5C illustrates the system from the perspective of a retailer connected to one or more distributors via label “B.”

As FIGS. 4A-C track products from cultivation through sales and FIGS. 5A-C tracks products from production through sales, there may be similarities. For sake of brevity, unless stated otherwise, similar terms or phrases are deemed to have similar meaning and therefore further examples or explanations may be omitted.

During the production phase 500, in FIG. 5A, production planning may be updated by demand level data from the POS system (block 502). The planned production may be added in the revenue streams. A producer or brand may be able to see inventory sell-through and demands in real time enabling them to make input decisions accordingly. A distributor may also tell producers what products they want.

Raw materials may be procured per plan (block 504). Data may be used to select the most profitable SKU mix based on all the data forward and back. ERP may be able to see the raw materials procured per plan and set availability/presale based on historical data to wholesale. Product items may be produced according to direct retail stocking and sell-through data algorithm (block 506). This process may comprise a Lucid Integration Point and data may be added to the Lucid Database. The product, or produced items, may be shipped to the processor/distributor (block 508). During this process, a door scanner may grab data encoded in the RFID tag of a product to perfect count in and out. This may enable full visibility from the time raw materials (RM) are selected until it reaches the consumer as a produced product item.

The distribution phase 520, in FIG. 5B, may begin with a finished good produced (block 522). A door scanner may grab data from an RFID tag on the finished good (FG) to perfect count in and out. The finished good (FG) item may be labeled according to state requirements (block 524). A Lucid ID may also be applied to the finished good and it may contain a SKU, UPC (Universal Product Code), and marketing data. Sales order (SO) may be placed and the finished good (FG) items may be cased (block 526). Database component for UPC may allow for tracking of product information and sales data. All items may be assigned to a case and Lucid ID Case Tag. Metrc tag information may be applied to cases and units to ensure compliance with regulatory requirements. ERP may also integrate with Lucid Touchpoint for outbound pick, pack, ship automation. Pick/pack may be completed (block 528), and as ERP shipment is completed, a Metrc transfer is created to facilitate the transfer of inventory from one licensed facility to another.

At the retail phase 540, in FIG. 5C, products may be received at a retail location which may include quality control (QC) and product counts (block 542). This may include a Lucid Integration Point and the scanning of the Lucid Case ID (identification). A door scanner may grab data from the RFID tag to perfect count in and out. This entire process besides inbound QC may be streamlined. For example, the reception labor may be streamlined. The point of sales (POS) system may receive shipment information and items are received into inventory (block 544). This inventory information may be added to the Lucid Database and the Lucid ID may be scanned by the POS system. As items are sold, state tracking may be updated. Customer and purchase information may be captured in a matrix and visible to any licensee, which may include dispensaries and retailers. Conversations may be scanned 100% because all information may be grabbed at check-out by the POS system.

FIG. 6 is an example software system 600 to implement the example systems of FIGS. 4A, 4B, 4C and 5A, 5B, 5C. One problem that manufactures can face is that some categories of products have long lead times such that decisions to manufacture a certain good need to be made a long time in advance (e.g., 6 months, 1 year, etc.) of when the product is shipped to distributors and ultimately to retailers. As such, there is a need for software to provide supply chain transparency from manufacture through a sale and predictive analytics such that producers can make these long-lead decisions with confidence. An enterprise resource planning (ERP) platform 602 integrates with a point-of-sale (POS) 604 and sales modeling platform 606. The ERP 602 provides procurement planning, production planning, inventory planning, sales planning, and distribution/logistics planning capabilities, and includes manufacturing work-in-progress (MFG-WIP). The POS system 604 can be a brick-and-mortar based system, a kiosk-based system, and/or a delivery app-based system, etc. The POS system 604 provides inventory management, sales data, and customer analytics. The illustrated system provides logistics and routing solutions for on-time inventory maintenance driven by a real time inventory view and sell-through. This visibility facilitates automated ordering and fulfillment. The sales modeling platform 606 facilitates production, ordering, and/or logistical planning using intelligent algorithms that predict future needs, for example, an on-time inventory system when the goods produced by the producer have a relatively long lead time.

ERP 602 and sales modeling platform 606 may provide software as a service (SaaS) revenue streams as standalone services or as part of the system 600. Quick response (QR) code, RFID, or industry standard ID and database may be used by the ERP 602 or POS system 604. Multiple APIs (application programming interfaces) or database integrations may integrate the sales modeling platform 606 with the frontend POS system 604.

The sales modeling platform 606 may be coupled with a dashboard interface 608 to provide a means of communication between producers and retailers. Data may be internally produced and third party modified. Third parties may be external parties or vendors who provide modified components for the system 600. Those modification may be specific to how that third party system integrates with the system 600.

The sales modeling platform may integrate with any frontend POS system and backend regulatory tracking system to dynamically predict inventory needs and sell-through for products. The sales modeling platform may use machine learning, predictive analytics, and integration with existing system to optimize the reorder process and improve the order fulfillment process. The sales modeling platform's ability to analyze data and make predictions leads to improved inventory management, reduced stockouts, improved shipping efficiency, and regulatory compliance.

More specifically, the sales modeling platform may be an agnostic order fulfillment algorithm that integrate with the POS system or any frontend POS system (e.g., one or more frontend POS systems) using application programming interfaces (APIs) or other communication protocols. The sales modeling platform may receive, from the POS system, transaction details, sales data, and delivery information. The sales modeling platform may receive transaction details such as customer name, product details, quantity, and price. The sales modeling platform may receive sales data such as the number of units sold for each product and time frame. The sales modeling platform may receive delivery information such as the customer's shipping address, delivery method, and delivery requirements. The sales modeling platform may use the transaction details, sales data, or delivery information to predict inventory needs and optimize the reorder process.

The sales modeling platform may use machine learning and predictive analytics to dynamically predict inventory needs and sell-through for products. To make prediction on inventory needs and sell-through for products, the sales modeling platform may analyze the sales data, inventory data, or delivery data. The sales modeling platform may analyze sales data to identify trends and patterns in product demand, thereby allowing dispensaries to optimize inventory levels and reduce stockouts. The sales modeling platform may analyze inventory data to identify slow-moving products and take appropriate actions to avoid overstocking. The sales modeling platform may analyze delivery data to identify which products have high delivery costs, thereby allowing dispensaries to optimize shipping costs and improve shipping efficiency.

The sales modeling platform may also use machine learning and predictive analytics to forecast the sell-through rate of products, thereby allowing dispensaries to optimize inventory levels and avoid overstocking. To make predictions on the sell-through rate of products, the sales modeling platform may analyze the sales data, delivery data, or promotional data. The sales modeling platform may analyze the sales data to identify trends and patterns in product demand, thereby allowing the dispensary to optimize inventory levels. The sales modeling platform may analyze delivery data to identify the time it takes to deliver the product and the frequency of the orders, thereby allowing dispensaries to optimize inventory levels. The sales modeling platform may analyze promotional data to identify the impact of promotions and discounts on product demand, thereby allowing dispensaries to adjust inventory levels accordingly.

The sales modeling platform may also integrate with the backend regulatory tracking system or database to ensure compliance with regulations and requirements. The sales modeling platform may receive, from the backend regulatory tracking system or database, compliance data, traceability data, and reporting data. The sales modeling platform may receive compliance data such as the regulatory requirements for products, the expiration dates, and any other compliance-related data. The sales modeling platform may receive traceability data such as the batch number, lot number, and serial number for products, thereby allowing the dispensaries to ensure traceability and product safety. The sales modeling platform may receive reporting data such as the required reports, audits, and other compliance-related data, thereby allowing dispensaries to stay in compliance with regulations.

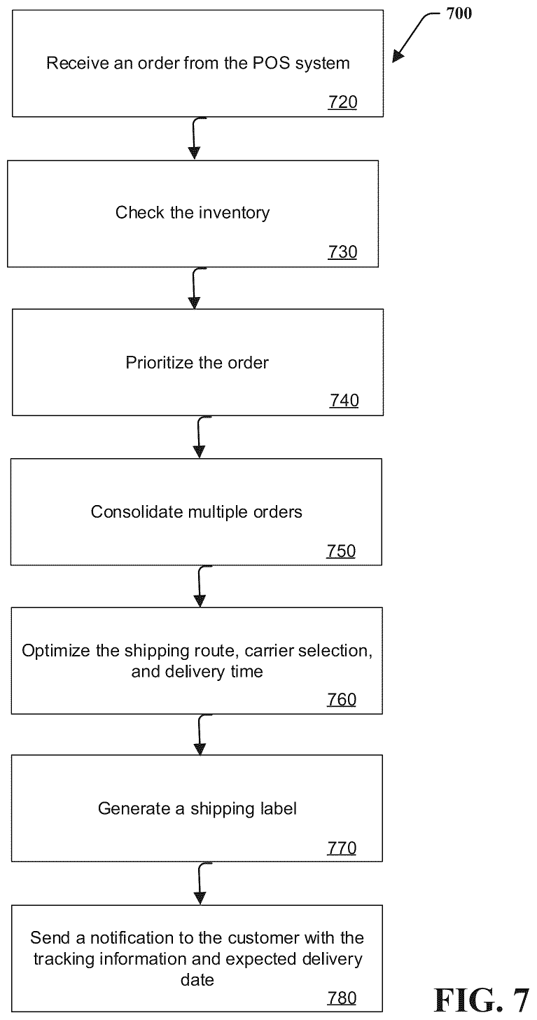

FIG. 7 shows an example of a method 700 that may be used by the sales modeling platform to automate and optimize the order fulfillment process. At step 720, the method 700 may comprise receiving, by the sales modeling platform, an order from the dispensary's point-of-sale system (e.g., the POS system). The order information may include details such as the product name, category, and quantity. At step 730, the method 700 may comprise checking, by the sales modeling platform, the dispensary's inventory to ensure the requested product is in stock. If the product is not available, the algorithm may prioritize the order based on availability and notify the customer of any potential delays. At step 740, the method 700 may comprise prioritizing, by the sales modeling platform, the orders based on several factors such as product availability, customer location, and delivery requirements. Orders with urgent or high-priority products or those with time-sensitive delivery requirements are given priority. At step 750, the method 700 may comprise consolidating, by the sales modeling platform, multiple orders that are going to the same location or are similar in their delivery requirements. For example, if multiple customers in the same area have ordered the same product, the algorithm will consolidate these orders and arrange for a single shipment to the same area/location to reduce shipping costs and improve delivery times. At step 760, the method 700 may comprise optimizing, by the sales modeling platform, the shipping route, carrier selection, and delivery time to ensure timely and accurate delivery. The sales modeling platform may use real-time shipping data to determine the most cost-effective and efficient shipping method for the orders. The sales modeling platform may also factor in carrier availability and peak delivery periods to help optimize delivery times. At step 770, the method 700 may comprise generating, by the sales modeling platform, a shipping label for the selected carrier. The label may include relevant order information such as the customer's name and address, product details, and delivery requirements. At step 780, the method 700 may comprise sending, by the sales modeling platform, a notification to the customer with the tracking information and expected delivery date. Customers can track their orders in real-time, thereby providing greater transparency and improving customer satisfaction.

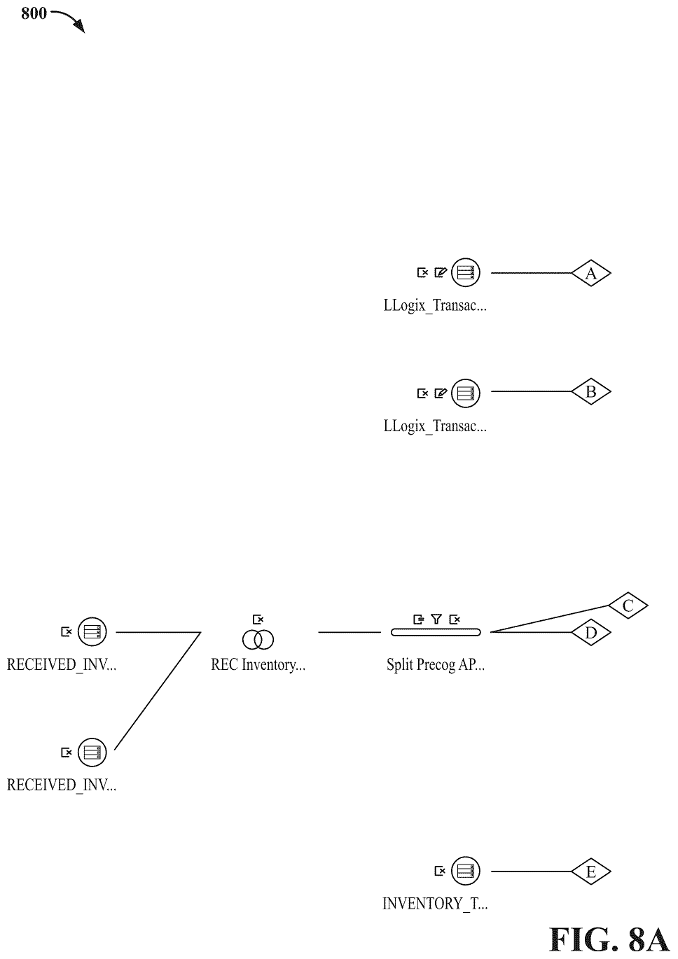

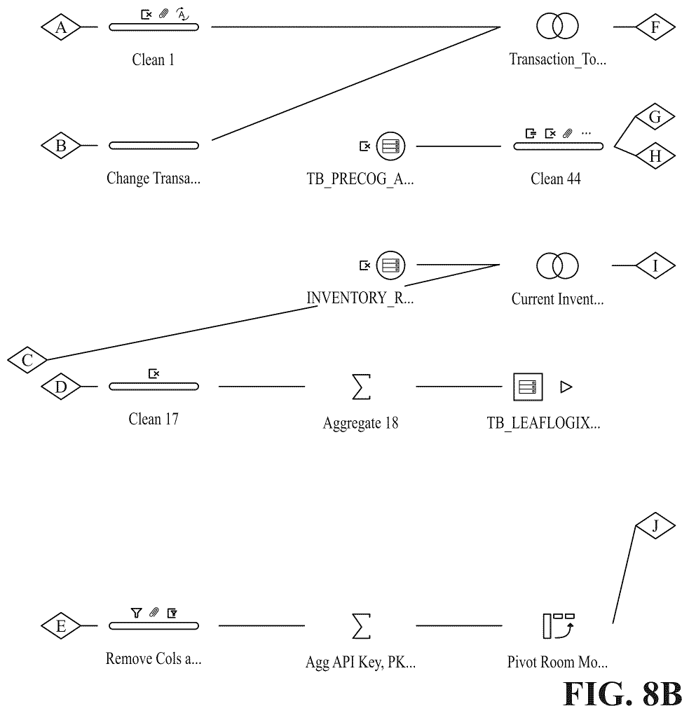

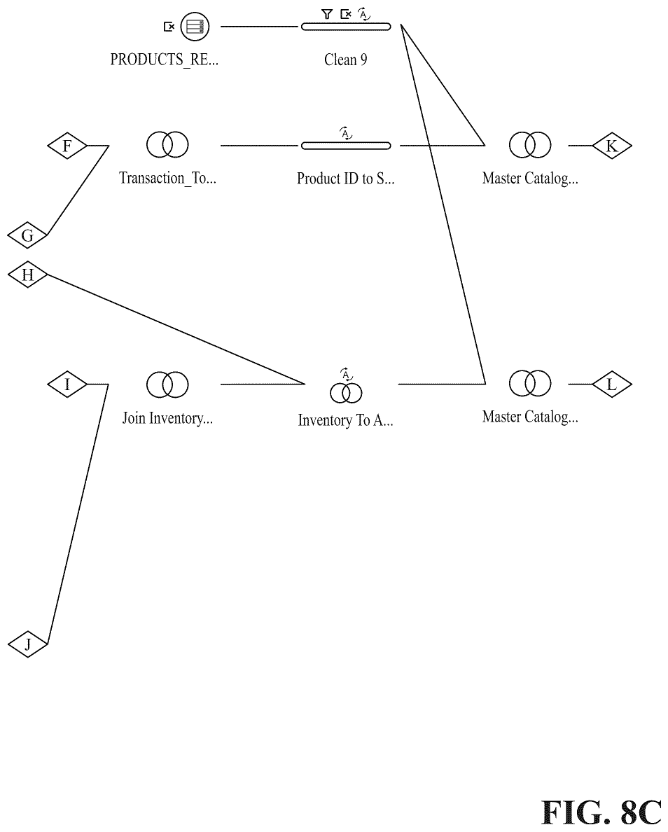

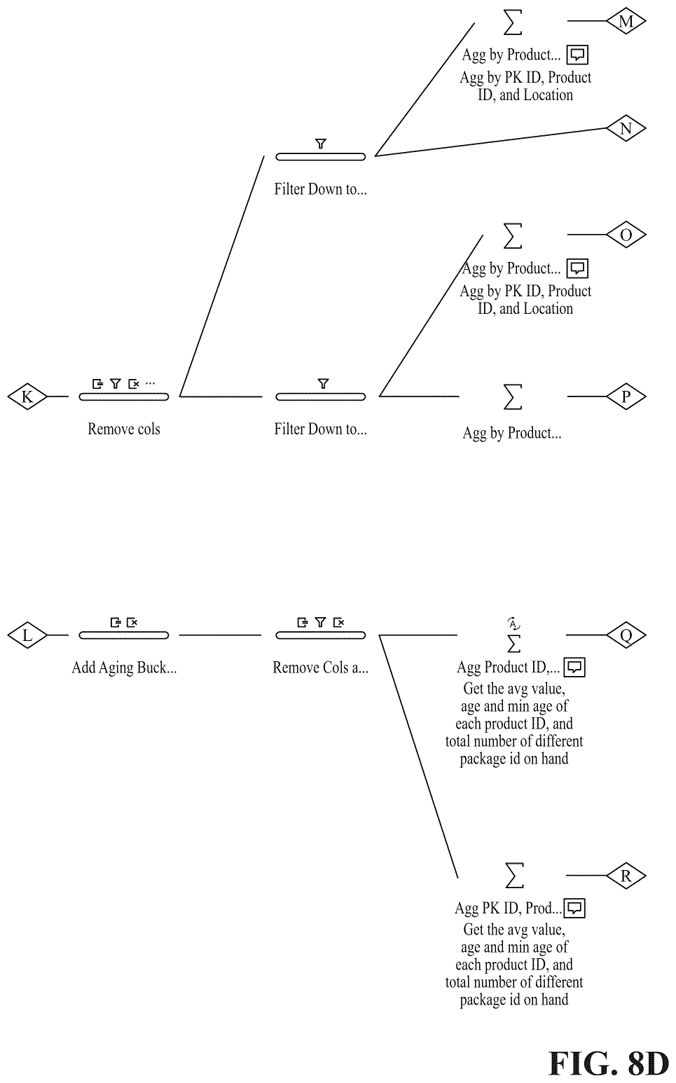

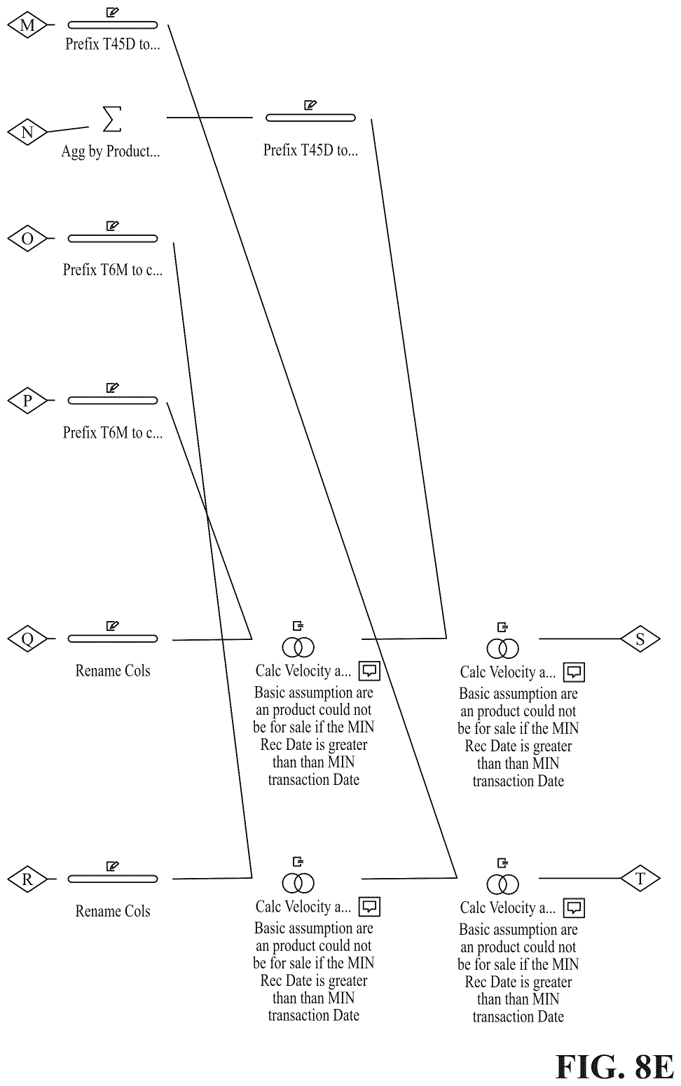

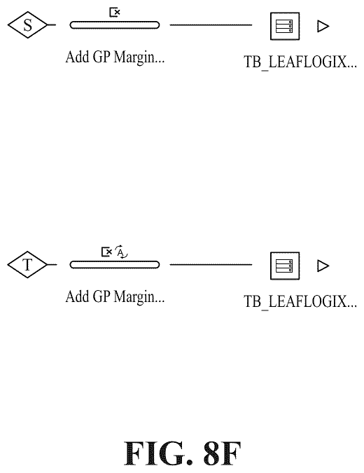

FIGS. 8A-F illustrate an algorithm 800 for calculating inventory velocity inventory and aiding with inventory management and planning. FIGS. 8A-F are connected by connectors A-T. The algorithm 800 may integrate data from both the Metrc and LeafLogix (POS) systems to determine the velocity and sell-through of products manufactured or sold at retail locations, thereby aiding in inventory management and planning. The algorithm 800 may analyze sales data for the last six months as well as the trailing 45 days to establish patterns and determine the velocity and sell-through of each product. Metrc may be utilized as a checkpoint to ensure that the data recorded by the front-end POS system matches the data reflected in the Metrc system. By utilizing the data from Metrc and LeafLogix, the algorithm 800 provides valuable insights into product demand, allowing for more accurate inventory management, restocking, and forecasting. The algorithm 800 is designed to be scalable, providing the flexibility to adapt to changing sales patterns and business needs. The aim is to optimize inventory velocity and turnover, thereby increasing profits and improving customer satisfaction.

Although the present embodiments have been illustrated in the accompanying drawings and described in the foregoing detailed description, it is to be understood that the system and methods are not to be limited to just the embodiments disclosed, but that the system and methods described herein is capable of numerous rearrangements, modifications and substitutions.

1. A kiosk for dispensing regulated consumables comprising:
an exterior housing;
a product storage cavity;
a user interface;
one or more verification area;
a dispensing area; and
one or more sensors to sense inputs and output instructions related to dispensing the regulated consumables.

2. The kiosk of claim 1, wherein the inputs and output instructions comprise verifying instructions, eligibility determining instructions, dispensing instructions, instructions related to storage conditions, instructions for alerts, instructions for collection and storage of data, or instructions for virtual assistance.

3. The kiosk of claim 2, wherein the data comprise user data, brand data, loyalty programs, shelf-life, or pricing.

4. The kiosk of claim 1, wherein the exterior housing is a protective or secure housing to prevent unauthorized access to components and products held within the kiosk and includes one or more secure doors or access points to the product storage cavity.

5. The kiosk of claim 1, wherein materials and colors of the exterior housing is chosen based on brands or products within the kiosk or chosen based on humidity or temperature control.

6. The kiosk of claim 1, wherein materials and colors of the storage cavity is similar or different than the exterior housing and chosen based on humidity or temperature control.

7. The kiosk of claim 1, wherein the user interface facilitates interaction between a user and the kiosk and facilitates selection of the regulated consumables by the user, wherein the user interface shows instructions or prompts to guide the user through verification, selection, and dispensing procedures.

8. The kiosk of claim 1, wherein the user interface comprises a display or on or more manual buttons.

9. The kiosk of claim 1, wherein the user interface comprises a component to receive tender including dollar bills, coins, credit and debit cards, mobile payment, or a combination thereof.

10. The kiosk of claim 1, wherein the user interface communicates to dispensing mechanisms to facilitate dispensing of selected product to the dispensing area.

11. The kiosk of claim 1, wherein the user interface displays a series of questions as part of a questionnaire, which comprises targeted questions to understand which product may best suit a user's needs and wants.

12. The kiosk of claim 1, wherein the user interface displays an option to connect to a third party such as a virtual sales person or customer representative, wherein the virtual sales person or customer representative provide an assessment and make recommendation through the user interface.

13. The kiosk of claim 1, wherein the verification area comprises slots configured to receive identification such as identification (ID) cards, fingerprint, facial recognition, or a combination thereof.

14. The kiosk of claim 1, wherein the verification area comprises one or more barcode readers, cameras, sensors, or a combination thereof.

15. The kiosk of claim 1, wherein the storage cavity comprises one or more sensors such as temperature sensors, moisture sensors, pressure sensors, or a combination thereof, to monitor corresponding conditions.

16. A regulated consumable dispensing system comprising:
a processor, operably coupled to a memory, that executes computer executable components stored in the memory, wherein the computer executable components comprise:
a verification component that assess eligibility of a user to receive selected product based on one or more identifiers;
a storage component that assesses and controls environmental conditions in a storage cavity that stores the regulated consumable;
dispensing component that dispenses to the user the selected product; and
assistance component that provides guidance to a user for selection of a product.

17. The regulated consumable dispensing system of claim 16, wherein the guidance comprises questionnaire or communication with a virtual sales person or customer representative.

18. The regulated consumable dispensing system of claim 16, wherein the environmental conditions comprises temperature, humidity, or lighting that is relevant to freshness and shelf-life of the regulated consumable inside the storage cavity of a kiosk.

19. The regulated consumable dispensing system of claim 16, wherein the storage component adjusts the environmental conditions through increased or decreased ventilation, cooling or heating, humidifiers or dehumidifiers, light or darkness, different colored or intensity of lights within the storage cavity.

20. A method for verifying product purchase eligibility comprising:
verifying, by a system, that a user at a kiosk matches identification provided by the user;
assessing, by the system, eligibility of the user to receive selected product based on one or more identifiers;
optionally assessing, by the system, user history at one or more kiosks;
optionally comparing, by the system, the user history to current quantity selection to determine if quantity limitations are exceeded; and
dispensing, by the system, to the user the selected product.

21. A method for automating and optimizing order fulfillment comprising:
receiving, by a sales modeling platform, an order for a customer from a dispensary's point-of-sale (POS) system;
checking, by the sales modeling platform, the dispensary's inventory to ensure a product in the order received is in stock;
prioritizing, by the sales modeling platform, one or more orders based on several factors such as product availability, customer location, and delivery requirements;
consolidating, by the sales modeling platform, the one or more orders that are going to a similar location or have a similar delivery requirements;
optimizing, by the sales modeling platform, shipping route, carrier selection, and delivery time to ensure timely and accurate delivery;
generating, by the sales modeling platform, a shipping label for a selected carrier; and
sending, by the sales modeling platform, a notification, via a dashboard interface, to the customer with the tracking information and expected delivery date.

22. The method of claim 21, wherein order information may comprise details such as product name, category, quantity, or a combination thereof.

23. The method of claim 21, wherein if the product is not available, the method further comprises prioritizing, by the sales modeling platform, the one or more orders based on availability and notifying the customer of any potential delays.

24. The method of claim 21, wherein the one or more orders with urgent or high-priority products or those with time-sensitive delivery requirements are given priority.

25. The method of claim 21, wherein if one or more customers in a similar area ordered similar products, the method further comprise consolidating, by the sales modeling platform, the similar products and arrange for a single shipment to the similar area to reduce shipping costs and improve delivery times.

26. The method of claim 21, further comprising utilizing, by the sales modeling platform, real-time shipping data to determine most cost-effective and efficient shipping methods for the one or more orders.

27. The method of claim 21, further comprising factoring in, by the sales modeling platform, carrier availability and peak delivery periods to optimize the delivery time.

28. The method of claim 21, wherein the shipping label comprises relevant order information such as customer's name and address, product details, and delivery requirements.

29. A system for automating and optimizing order fulfillment of products comprising:
an enterprise resource planning (ERP) platform provides procurement planning, production planning, inventory planning, sales planning, and distribution and logistics planning;
a point-of-sale (POS) system provides inventory management, sales data, and customer analytics;
a sales modeling platform facilitates production, ordering, and logistical planning using intelligent algorithms that predict future needs; and
a dashboard interface coupled with the sales modeling platform as a means of communication between producers and retailers.

30. The system of claim 29, wherein the POS system is a brick-and-mortar based system, a kiosk-based system, or a delivery app-based system.

31. The system of claim 29, wherein the sales modeling platform provides logistics and routing solutions for on-time inventory maintenance driven by real time inventory view and sell-through.

32. The system of claim 29, wherein the sales modeling platform uses machine learning and predictive analytics to dynamically predict inventory needs and sell-through for the products, thereby allowing the retailers and dispensaries to optimize inventory levels and avoid overstocking.
